(19) United States
(12) Patent Application Publication
(10) Pub. No.: US 2016/0277840 A1
(43) Pub. Date: Sep. 22, 2016

(54) RING SHAPED MEMBRANE FOR AN ELECTRO-ACOUSTICAL LOUDSPEAKER

(71) Applicant: Lars Goller, Herning (DK)

(72) Inventor: Lars Goller, Herning (DK)

(21) Appl. No.: 14/923,341

(22) Filed: Oct. 26, 2015

Related U.S. Application Data
(63) Continuation of application No. 12/452,833, filed on May 25, 2010, now Pat. No. 9,173,034.

(30) Foreign Application Priority Data
Jul. 25, 2007 (DK) PA 2007 01091
Dec. 4, 2007 (DK) PA 2007 01737

(51) Int. Cl. H04R 7/18; H04R 9/06; H04R 7/12

(52) U.S. Cl. CPC H04R 7/18; H04R 7/127; H04R 7/122; H04R 9/06

(57) ABSTRACT

A ring-shaped membrane for an electro-acoustical loudspeaker, where said membrane may include two or more dome-shaped annulus concentrically arranged around a central portion through which an imaginary axis of symmetry passes, where an outer periphery of said membrane is suitable to be attached to a surround; where the central portion is attached to a tower, which again is fastened to the loudspeakers driver, wherein the angle between a plane being perpendicular to the axis of symmetry and the attachment of the membrane to the tower is in the interval 0 degrees to 40 degrees, and in some embodiments 30 degrees.

### CROSS-REFERENCE TO RELATED APPLICATIONS

The present application claims priority to U.S. patent application Ser. No. 12/452,833 entitled “RING SHAPED MEMBRANE FOR AN ELECTRO-ACOUSTICAL LOUDSPEAKER,” filed May 25, 2010, which claims priority to and is a National Stage Entry of PCT Application No. PCT/DK2008/000278, filed Jul. 25, 2008, which claims priority to Danish Application No. PA 2007 01737 filed Dec. 4, 2007, and also claims priority to Danish Application No. PA 2007 01091 filed Jul. 25, 2007, the disclosures of which are incorporated herein by reference in their entireties as if fully set forth herein.

### BACKGROUND

1. Field of the Invention

The present invention relates to a ring shaped membrane for an electro-acoustical loudspeaker.

2. Description of Related Art

Electro-acoustical loudspeakers are widely used and traditionally comprise a chassis in which a driver and a membrane are arranged. The driver is typically a magnetic system defining an air gap, in which air gap the magnets have been arranged such that a magnetic flux will be present across the gap. By having a voice coil connected to the membrane and arranging set voice coil in the air gap and furthermore connecting the coil to an amplifier, the current in the coil will be influenced by the magnetic field in the gap and thereby move up and down depending on the direction of the current in the coil.

The voice coil is traditionally connected to the membrane such that, as the voice coil moves back and forth in the air gap, the membrane will move accordingly and thereby create the sound.

From JP 2006041783 is a speaker system known comprising a membrane consisting of two dome shaped annulus arranged coaxially. The coil is attached to the connection between the inner and outer annulus and arranged in an air gap in the driver motor. The center portion of the inner annulus is fastened to an upper portion of the loudspeaker driver motor. As the coil moves up and down in the airgap, sound will emit from the surface of the membrane. The emission direction will be substantially perpendicular to the surface of the membrane, in each point on the membrane. In action the inner annulus will thereby emit sound (waves) towards the center from the portions of the membrane being angled towards the central portion of the membrane. These sound waves will instantly interfere with sound waves deriving from the same membrane part diametrically opposite on the membrane. This interference will cause a certain degree of distortion in the resulting “sound picture”..

### SUMMARY

It is an object of embodiments of the present invention to provide a ring shaped membrane, which alleviates drawbacks of prior art ring dome constructions.

The present invention addresses this by providing a ring shaped membrane for an electro-acoustical loudspeaker, where said membrane comprises two or more dome-shaped annulus concentrically arranged around a central portion through which an imaginary axis of symmetry passes, where an outer periphery of said membrane is suitable to be attached to a surround; where the central portion is attached to a tower, which again is fastened to the loudspeaker's driver, wherein the angle between a plane being perpendicular to the axis of symmetry and the attachment of the membrane to the surround the surround resp. the tower is in the interval 0 degrees to 40 degrees, most preferred around 30 degrees.

The plane as defined above is traditionally the plane in which the chassis of the loudspeaker construction will be placed. As the sound is generated by the membrane, the tower, to which the central portion of the membrane is fastened, does not interfere with the sound generation of the present invention. By furthermore fastening a central portion of the membrane to the tower, without having a plug interfering with the central portion just in front of the membrane, the sound is free to be emitted from the entire surface of the membrane. For steeper angles a problem of interference would arise but due to the shallow angels used within the present invention in the interval 0 degrees to 40 degrees the interference problems are avoided and at the same time a relatively large effective area radiating sound is provided. Traditionally it is desirable to provide as much membrane surface perpendicular to the direction into which it is desirable to radiate the sound but once the membrane becomes too flat undesirable effects will arise in the membrane such as for example wobbling, distortion, resonances and the like having a detrimental effect on the sound reproducing properties of such a membrane.

With the present invention, however, it has been found that by providing annular shaped ring segments concentrically arranged around a central axis of symmetry where the angles between the membrane material and the plane discussed above which is typically the plane where the membrane is fastened to the chassis, is in the interval 0 degrees to 40 degrees, a very advantageous construction is achieved in that a relatively large and effective membrane area is provided in relation to the prior art devices such that a higher efficiency may be achieved with a smaller area and thereby with a more compacted construction.

Tests have indicated that the membrane construction according to the present invention in relation to prior art devices has an efficiency which is 3 to 5 dB more than the traditional membranes. Furthermore, the sound distribution due to the lack of the plug in the center portion of the membrane is greatly improved as compared to prior art devices.

In a further advantageous embodiment of the invention the voice coil is attached to the membrane and preferably the voice coil is attached in a point coinciding with the lowest point between the two innermost annular dome-shaped annulus. In this manner the voice coil is fastened to the strongest point of the membrane for transferal of the mechanical forces arising from the movement of the voice coil in an air gap as discussed above. It is therefore possible to transfer relatively large forces to the ring-shaped membrane's annuluses even at the shallow angles according to the invention, providing for the enlarged effective membrane area such that in addition to a better sound reproduction with no or negligible sound interference the effectiveness of the membrane as such is also greatly improved due to the voice coil arrangements in the relatively strong section of the membrane, where the forces may be evenly distributed to the two concentrically arranged dome-shaped annulus.

In a still further advantageous embodiment the central portion of the membrane is fastened to the tower by means of an adhesive. And in a still further advantageous embodiment, the tower is provided with a cavity, which cavity is at least partly filled with an adhesive, thereby connecting the central portion of the membrane to the tower. The adhesive may optionally retain elastic or resilient properties during its service life.

In this manner the fastening of the membrane to the tower is carried out such that no concentration of forces and thereby tension in the membrane is present. Furthermore, by having the adhesive provided with resilient or elastic properties, the adhesive as such is also an important member in dampening the moving membrane whereby any distortion or wobbling in the membrane, which could arise, will be dampened by the adhesive in the cavity. As furthermore, the adhesive is arranged on the backside of the membrane relative to the sound admitting surface, the adhesive as such will have no influence on the sound emitting properties of loudspeaker incorporating such a membrane, and thereby the membrane's characteristics as explained above will be maintained free of interference from the fastenings.

Furthermore, as set out in a further advantageous embodiment of the invention, designing the adhesive such that it has a certain viscosity and thereby pre-designing the mechanical dampening properties of the membrane the choice of adhesive may actually be chosen such that it is possible to adjust the mechanical dampening properties of the membrane by adjusting the viscosity of the adhesive. Typically adhesives containing long polymers are preferred, in that their elastic properties will remain even when exposed to extended mechanical action as is the case for loudspeakers of this type. The person skilled in the art will know how to modify the adhesives in a manner in order to obtain the desired viscosity.

In a manner exhibiting comparable advantages as stated above the membrane in a further advantageous embodiment is provided with a V-shaped portion along and immediate adjacent the outer periphery, which V-shaped portion is received in a reservoir either provided in the surround or in the chassis, which reservoir connects with the membrane by means of an adhesive. In some embodiments, the adhesive may be a foam.

In a further advantageous embodiment of the invention an alternative to fastening the membrane by means of an adhesive is an embodiment wherein the central portion of the membrane is fastened to the tower by means of fastening member, having a head portion and a stem, where said stem penetrates the membrane and is fastened to the tower, and where said head has a size maintaining the membrane in contact with said tower. The head portion of the fastening member shall be designed such that it does not interfere with the admission of sound which is to say that the head portion should be relatively shallow and not have a size substantially larger than the cross section of the tower in connection with the membrane.

The relatively shallow design of the membrane, in the direction in which the membrane extends along the axis of symmetry in combination with the dome-shaped annulus and central fastening, provides for a very stable construction such that the voice coil in the air gap does not exhibit much play, whereby the air gap may be optimized whereby thereby the magnetic field in the air gap is increased, whereby the membrane as such may be persistent to higher power output.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 illustrates a cross section of a membrane according to exemplary embodiments of the invention; and

FIG. 2 illustrates a detailed view of the fastening of the membrane centrally to the tower in accordance with exemplary embodiments.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

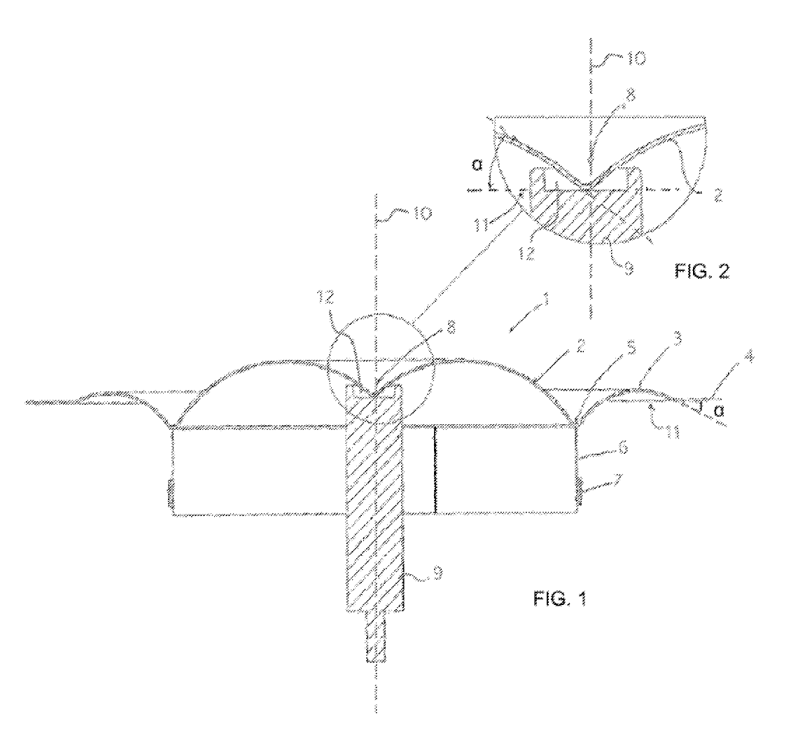

Turning to FIG. 1, the membrane 1 comprises two dome-shaped annulus 2,3 arranged concentrically one inside the other. Along the outer most periphery, adjacent the outer dome-shaped annulus 3 is provided a flange 4 which is suitable in a traditional way to be fastened to a surround and thereafter to a loudspeaker chassis. Between the two concentrically arranged dome-shaped annulus 2, 3 is a valley 5 defining the lowest point between the two innermost annual dome-shaped annulus 2,3. A voice coil cylinder 6 carrying a voice coil 7 is attached in this point. As the voice coil cylinder moves up and down in response to the direction change of the current in the voice coil, when arranged in a magnetic field, the forces will be distributed in the ring segments of the dome-shaped annulus 2, 3 without wasting energy in bending the membrane, but most of the energy will be used in moving the dome-shaped annulus back and forth thereby emitting sound.

Centrally, a central portion 8 of the membrane is fastened to a tower 9, which tower again is fastened to a loudspeaker driver construction (not illustrated). The fastening of the central portion 8 to the tower 9 will be explained with reference to FIG. 2 below.

The membrane 1 is symmetrical around an axis of symmetry 10 going through the central portion 8 of the membrane. An imaginary plane 11 arranged perpendicular to the imaginary axis of symmetry 10 will be referred to in order to explain the detailed properties of the membrane 1. Along the periphery i.e. inside the flange 4 the outermost dome-shaped annulus is arranged at an angle of no more than 40 degrees. in relation to the imaginary plane 11 as illustrated by the angle a. In some embodiments, the inner-dome shaped annulus 2 may be attached to the side of a tower 9, the top of a tower 9, another portion of a central tower 9, or the like.

Turning to FIG. 2 the detailed fastening arrangement of the central portion 8 to the tower 9 is illustrated. The angle a between the imaginary plane 11 and the inner dome-shaped annulus 2 is to be arranged in the interval including 0 degrees to 40 degrees. In the particular embodiment the angle a is approximately 30 degrees, which has proven to be a desirable compromise in that the strength that the dome-shaped annulus in relation to the effective membrane area is relatively high, such that a very good efficiency with very low distortion is achieved. In some embodiments, the adhesive may be a foam.

The tower is furthermore in this embodiment provided with a cavity 12 which in order to fasten the membrane 2 to the tower 9 may be filled with an adhesive (not illustrated). The adhesive may be selected having an appropriate viscosity such that the adhesive will exhibit elastic or resilient properties which in turn will act as a dampener on the membrane therefore in addition to fastening the central portion 8 of the membrane to the top of the tower 9 the fastening will also exhibit dampening properties. The dampening properties will not interfere with the membrane's ability to emit sound and as such in contradiction to other ring shaped or dome shaped membranes implementing a plug with the construction with a cavity in the top of the tower not influence the effective membrane area significantly.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional components, as particular applications may require.

What is claimed is:

1. A ring-shaped membrane for an electro-acoustical loudspeaker, the membrane comprising:
two or more dome-shaped annuluses concentrically arranged around a central portion through which an axis of symmetry passes, the membrane having an outer periphery adapted to be attached to a surround;
wherein the central portion of the membrane is attached to a portion of a tower connected to a loudspeaker driver, and the angle between a plane being perpendicular to the axis of symmetry and the attachment of the membrane to the tower is in the interval 0° to 40°.

2. The membrane of claim 1, wherein the central portion of the membrane is attached to a side of the tower.

3. The membrane of claim 1 wherein a voice coil cylinder is attached to the membrane at an intersection of two innermost dome-shaped annuluses.

4. The membrane of claim 1 wherein a portion of the membrane is attached to the tower with an adhesive between the membrane and the tower.

5. The membrane of claim 4, wherein the adhesive is designed to have a certain viscosity such that the mechanical dampening properties of the membrane may be adjusted by adjusting the viscosity.

6. The membrane of claim 5 wherein the adhesive is a foam.

7. The membrane of claim 1 wherein the central portion of the membrane comprises an opening and is fastened to the tower by means of fastening member, having a head portion and a stem, where said stem penetrates the membrane through the opening and is fastened to the tower, and where said head has a size maintaining the membrane in contact with said tower.

8. The membrane of claim 1, wherein the intersection of the two innermost annuluses is positioned at a lowermost axial position of the membrane.

9. The membrane of claim 8, wherein the central portion of the membrane is attached to the tower at a higher axial position than the intersection of the two innermost annuluses.
